(19) United States
(12) Patent Application Publication
(10) Pub. No.: US 2009/0103753 A1
(43) Pub. Date: Apr. 23, 2009

(54) Three-dimension array structure of surround-sound speaker

(75) Inventor: Wei Hsu, Taipei (TW)

Correspondence Address: BIRCH STEWART KOLASCH & BIRCH, PO BOX 747, FALLS CHURCH, VA, 22040-0747, US

(73) Assignee: Weistech Technology Co., LTD

(21) Appl. No.: 11/976,051

(22) Filed: Oct. 19, 2007

(51) Int. Cl. H04R 5/00

(52) U.S. Cl. 381/307

(57) ABSTRACT

The present invention provides a single column surround-sound speaker with multiple speaker unit arrangements. In one aspect of the present invention, the single column surround-sound speaker includes a cylinder with at least three openings formed thereon spirally, at least three full range speakers attached in the openings, a base supporting the cylinder, and a sound field reconstructing unit formed within the cylinder or the base or outside of the cylinder and the base, wherein the sound field reconstructing unit is coupled to the full range speakers.

### FIELD OF THE INVENTION

The present invention relates to a column surround-sound speaker, and particularly to a single column surround-sound speaker with multiple speaker unit arrangements.

### BACKGROUND OF THE INVENTION

The current trend in sound reproduction is to use an arrangement of typically four to five loudspeakers. For example, a conventional speaker system includes a front speaker located in proximity to the video image for providing acoustic output based upon a summation signal of the component left and right (L+R) channels of the audio signal. A rear speaker located to the rear of the viewing area provides acoustic output based upon a difference signal, (L−R) or (R−L), between the left and right channels. Left and right speakers located to the respective left and right sides of the viewing area. The left and right channels speakers reproduce a difference signal, (L−˜R) or (R−˜L), where ˜ is a gain which may vary or may be a value fixed between zero and unity. Output to the left and right speakers is band limited to substantially filter out frequency components below a predetermined threshold. A bass speaker may also be provided to output the low frequency components of a (L+R) summation signal. The (L+R) summation signal input to the front speaker assists in localizing dialog to the video image. The (L−˜R) or (R−˜L) difference signal substantially removes dialog sound so that the side and rear speaker output primarily comprises sonic ambience and surround sound effects. Band limiting the left and right speakers further assists in localizing dialog to the video image.

The conventional surround-sound speaker systems as mentioned above usually need four to five speakers located in different positions to reproduce surround sound effects and the positions of these speakers are substantially unchangeable. Therefore, the user needs to arrange space for different speakers in different directions in a room. It is inconvenient and space-wasting for the user. Thus, there is still a demand for providing a space-saving and position changeable surround-sound speaker.

### SUMMARY OF THE INVENTION

The present invention provides a single column surround-sound speaker with multiple speaker unit arrangements. In one aspect of the present invention, the single column surround-sound speaker includes a hollow pillar with at least three openings formed thereon spirally, at least three full range speakers attached in the openings, a base supporting the hollow pillar, and a sound field reconstructing unit formed within the hollow pillar or the base or outside of the hollow pillar and the base, wherein the sound field reconstructing unit is coupled to the at least three full range speakers.

In another aspect of the present invention, the single column surround-sound speaker includes a hollow pillar with at least three openings formed thereon asymmetrically or symmetrically, at least three full range speakers attached in the openings, a base supporting the hollow pillar, and a sound field reconstructing unit formed within the hollow pillar or the base or outside of the hollow pillar and the base, wherein the sound field reconstructing unit is coupled to the at least three full range speakers. The full range speakers are coupled with each other serially or parallelly. The sound field reconstructing unit includes a digital signal processor and a digital delay circuit.

One advantage of the present invention is that the single column surround-sound speaker can singly achieve surround sound effects.

Another advantage of the present invention is that the size of the single column surround-sound speaker can be greatly decreased because of the compact full-range speaker.

Still another advantage of the present invention is that the single column surround-sound speaker can be placed anywhere in a room with the surround sound effects remained at the same level.

Still another advantage of the present invention is that the single column surround-sound speaker can be convenient to use and position changeable and space-saving for the user.

These and other advantages will become apparent from the following description of preferred embodiments taken together with the accompanying drawings and the appended claims.

### BRIEF DESCRIPTION OF THE DRAWINGS

The present invention may be understood by some preferred embodiments and detailed descriptions in the specification and the attached drawings below. The identical reference numbers in the drawings refer to the same components in the present invention. However, it should be appreciated that all the preferred embodiments of the invention are only for illustrating but not for limiting the scope of the Claims and wherein:

FIG. 1 is a front view of the single column surround-sound speaker in accordance with one embodiment of the present invention.

FIG. 2 is a rear view of the single column surround-sound speaker in accordance with one embodiment of the present invention.

FIG. 3 is a side view of the single column surround-sound speaker in accordance with one embodiment of the present invention.

FIG. 4 is a front view of the single column surround-sound speaker in accordance with another embodiment of the present invention.

FIG. 5 is a block diagram of the sound field reconstructing unit in accordance with one embodiment of the present invention.

### DETAILED DESCRIPTION OF THE PREFERRED EMBODIMENT

The invention will now be described with the preferred embodiments and aspects and these descriptions interpret structure and procedures of the invention only for illustrating but not for limiting the Claims of the invention. Therefore, except the preferred embodiments in the specification, the present invention may also be widely used in other embodiments.

The present invention discloses a single column surround-sound speaker with multiple speaker unit arrangements. In one embodiment of the present invention, the speaker unit arrangements may be spiral. In another embodiment of the present invention, the speaker unit arrangements may be asymmetric or symmetric. The single column surround-sound speaker of the present invention achieves surround sound effects with only one column speaker by such speaker unit arrangements and by the 3D sound field reconstruction technique which will be described hereafter.

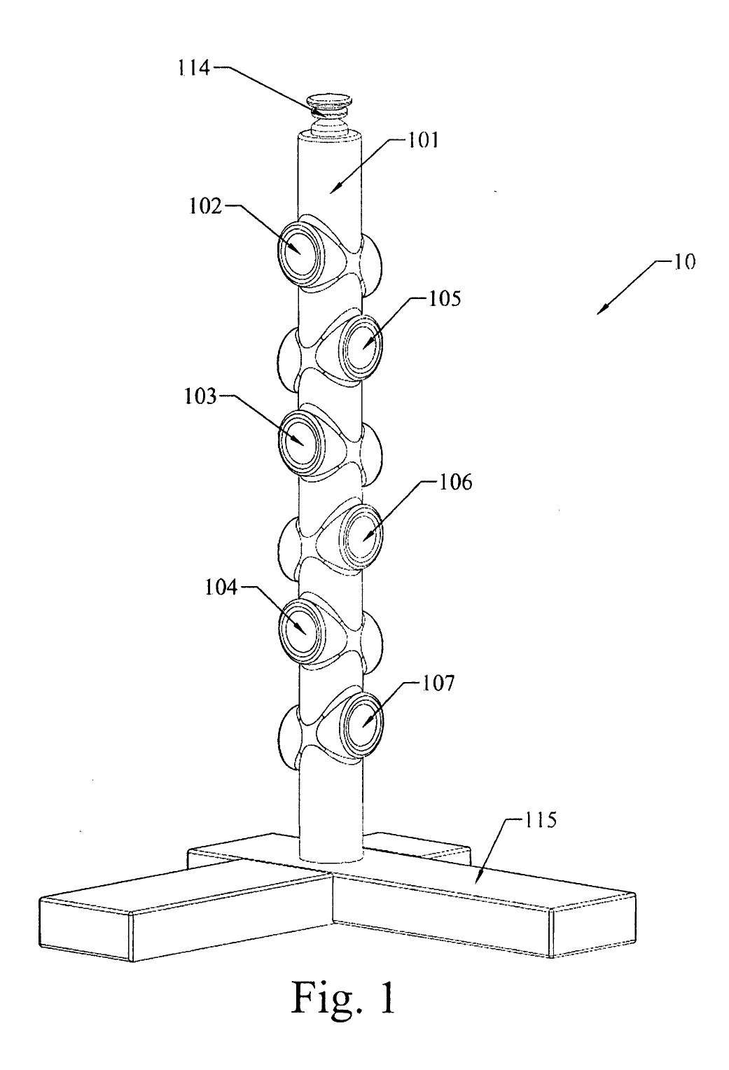

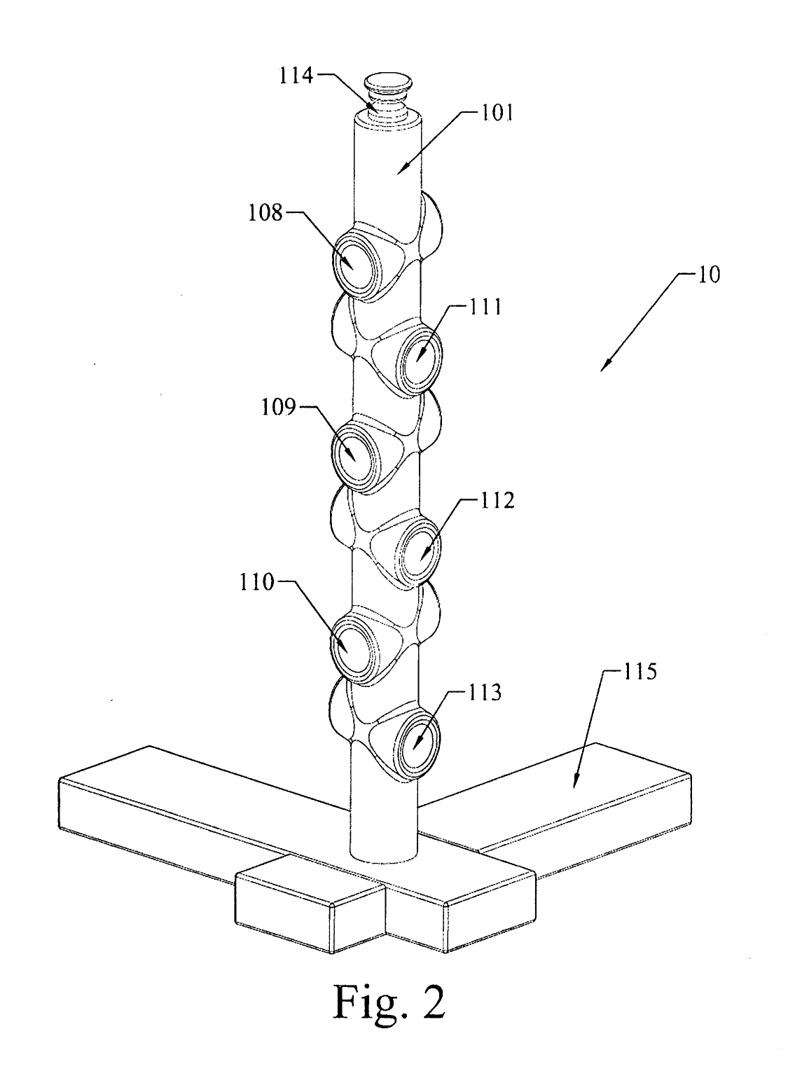

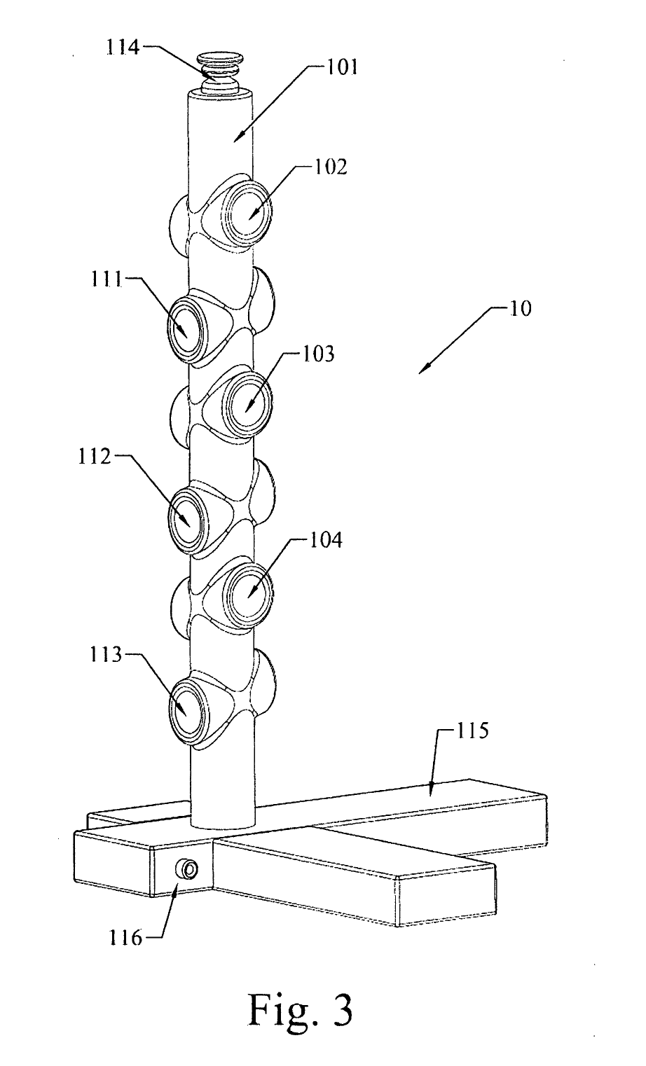

With reference to FIG. 1-3, in one embodiment of the present invention, the single column surround-sound speaker 10 includes a main hollow pillar, for example, a cylinder 101 with pluralities of openings formed thereon in four directions or orientations. In one embodiment of the present invention, the cylinder 101 is made of wood, plastics, stainless steel, alloy, or metal, for instance. There are, for instance, at least three openings formed on the cylinder 101 in a line in each direction. Each opening is assembled with a real or fake speaker unit. In one embodiment, the real speaker units are full-range speakers with high performance. As shown in FIG. 1-3, openings 102, 103, 104 are respectively opposite to openings 108, 109, 110 while openings 105, 106, 107 are respectively opposite to openings 111, 112, 113. In one embodiment of the present invention, the diameters of the openings 102-113 are about 45 mm to 55 mm, which is for illustrating but not for limiting the present invention. Moreover, the openings 102, 104, 105, 107, 109, and 112 are assembled with real speaker units while the openings 103, 106, 108, 110, 111, and 113 are assembled with fake speaker units. The fake speaker units are not essential elements. Therefore, the real speaker units are arranged clockwise (or counterclockwise) spirally on the cylinder 101 and coupled with each other parallelly or serially for the single column surround-sound speaker 10 to produce sound toward four directions to achieve surround sound. The lower end of the cylinder 101 is placed on a base 115 to support the cylinder 101. Preferably, two orthogonalized wooden boards are provided as the base 115. It should be noted that the base 115 can be formed into any shape. In one embodiment of the present invention, the base 115 is made of any suitable material such as palisander, stone, metal boards or the like. An audio signal input 116 is formed on the side surface of the base 115. The upper end of the cylinder 101 is assembled with a decorative head 114 which is plated with metal, for example 1012 iron.

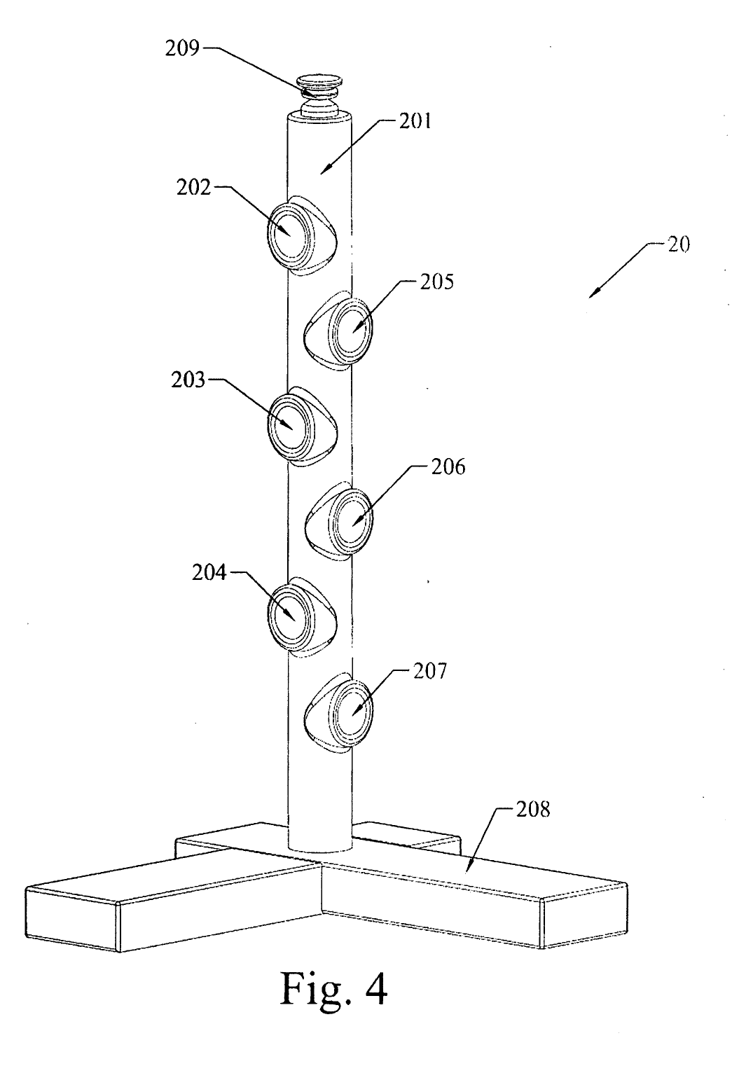

In another embodiment of the present invention, the arrangements of the speaker units may be asymmetric or symmetric without fake speakers. With reference to FIG. 4, the single column surround-sound speaker 20 includes a main cylinder 201 with, for example, six openings formed thereon asymmetrically in two directions. In one embodiment of the present invention, the cylinder 201 is made of wood, plastics, metal, alloy, stainless steel or the like. There are three openings formed on the cylinder 201 in a line in each direction. Each opening 202-207 is assembled with a real speaker unit. In one embodiment, the real speaker units are full-range speakers with high performance. In one embodiment of the present invention, the diameters of the openings 202-207 are about 45 mm to 55 mm, which is for illustrating but not for limiting the present invention. Therefore, the real speaker units are arranged asymmetrically on the cylinder 201 and coupled with each other parallelly or serially for the single column surround-sound speaker 20 to produce sound toward two directions to achieve surround sound. The lower end of the cylinder 201 is placed on a base 208 to support the cylinder 201. Preferably, two orthogonalized wooden boards are provided as the base 208. It should be noted that the base 208 can be formed into any shape. In one embodiment of the present invention, the base 208 is made of any suitable material such as palisander, stone, metal boards or the like. The upper end of the cylinder 201 is assembled with a decorative head 209 which is plated with metal, for example 1012 iron.

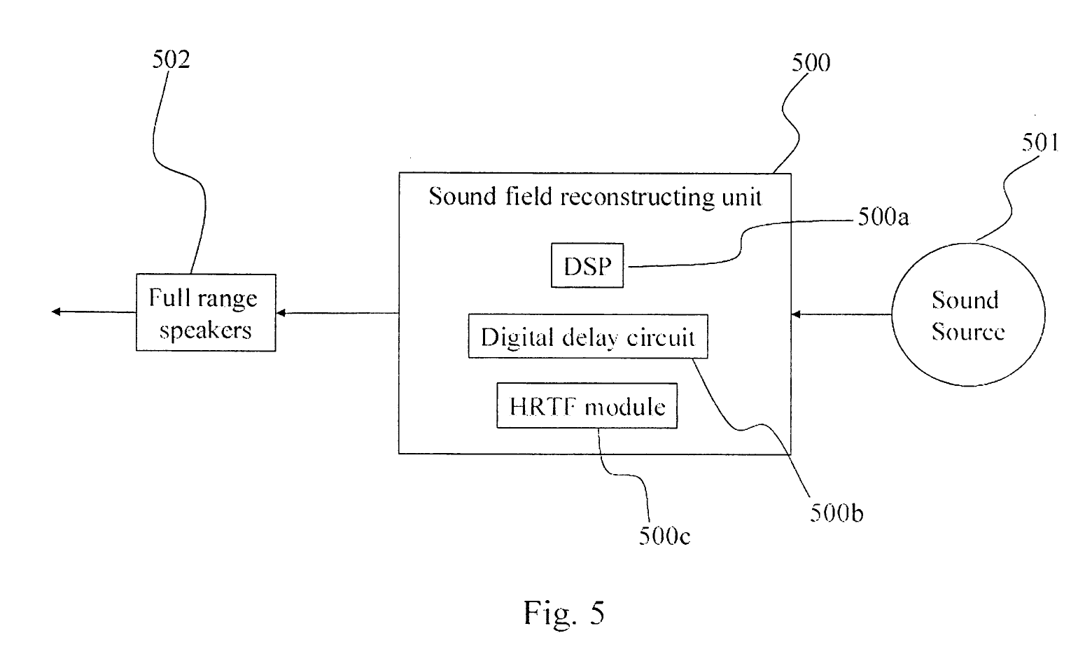

With reference to FIG. 5, in one embodiment of the present invention, the single column surround-sound speaker may achieve surround sound with only one column speaker by aforementioned speaker unit arrangements and by the sound field reconstructing unit 500 which is formed in the cylinder and coupled to the full range speakers 502. In order to attain the purpose of the present invention, the sound field reconstructing unit 500 is required, wherein the sound field reconstructing unit 500 mainly includes a Digital Signal Processor (DSP) 500a, a digital delay circuit 500b, and a HRTF (Head Related Transfer Function) module 500c to clearly reproduce localized sound image utilizing the 3D sound field reconstruction technique by real-time digital filtering, by dynamic compression algorithm, and by rebuilding approximate time delay for different sounds. The sound field reconstructing unit 500 may be provided outside the single column surround-sound speaker or embedded in the base or the cylinder of the surround-sound speaker. The 3D sound field reconstruction technique also includes rich HRTF (Head Related Transfer Function) database, latest sound field simulation technology, such as BIEM (Boundary Integral Equation Method) and FEM (Finite Element Method), virtual sound source technology, subjective measurement technology, and sound stage conversion technology which allows the single column surround-sound speaker to reproduce a clear sound imaging with minimum sound quality change such as the reflection and reverberation element etc. The high quality reproduction digital filters are realized by the Digital Signal Processor (DSP) 500a and implemented by HRTF module 500c with measurement database as well as full theoretical model. The 3D sound field reconstruction technique creates an extremely wide sound stage without introducing any noticeable coloration of the original signal and generates the illusion of five virtual loudspeakers from the aforementioned speaker unit arrangements by filtering to achieve surround sound.

In order to simulate real sound source, which locates at an arbitrary point in 3D space, the 3D sound field reconstruction technique introduces HRTF (Head Related Transfer Function) database, which was defined as a set of transfer function between sound source to two ears of a human head. The HRTF depends on the coordinate and frequency of a point of sound source, and also has individual dependency of the listeners. HRTF can be realized as an impulse response of the time domain representation of HRTF referred as HRIR (Head Related Impulse Response). This HRTF or HRIR consists of a complete mathematical model based on acoustic wave theory and actual measurements that have been carried out for huge samples using dummy head microphones and human heads. The theoretical HRTF has several advantages such as suitable characteristics for music reproduction due to its natural and simple frequency response and less computational tasks.

In one embodiment, the real speaker units assembled in the openings on the cylinder may be compact full-range speakers with high performance. For example, a full range loudspeaker has a diaphragm with a voice coil disposed about its perimeter and extending in a gap into which the flux of a rare earth magnet is focused, as disclosed in U.S. Pat. No. 6,654,476 which is incorporated herein by reference. The voice coil may have two or more windings that are connected in parallel. These may be layered on top of one another, so that the impedance of the coil, as well as its depth in the direction of motion, are low. The voice coil is preferably implemented using a polyimide form or bobbin which has patterned lead-in conductors embedded therein to bring power to the perimeter of the coil. The lead-in conductors connect at one end to wire windings wound on the bobbin, and extend at their other end to, or through, an opening located centrally behind the diaphragm, providing a robust ribbon input connection. The ribbon lead-in may be symmetrical, and the central opening further provides an air channel which may, for example, couple to an auxiliary chamber to further enhance the acoustic output. The magnet may be an annular or ring magnet, and it rests on a first, or lower, generally cup-shaped pole piece, that cooperates with a second, or upper generally washer-shaped pole piece to define the flux gap in a region extending around the perimeter of the diaphragm.

Preferably, the upper surface of the washer is inclined radially inward to an edge of diminished thickness, to reduce central mass. This also provides added clearance at the front of the magnet assembly for accommodating the lead-in ribbon in a widely-curved arc without contact, and reduces the length of the central passage to prevent undesirable whistling when the diaphragm is subject to large displacement. The diaphragm may be domed to provide further clearance, and is weighted or mass-loaded by applying a material such as butyl rubber to lower its natural resonant frequency, thus extending its useful response band while providing sharp rolloff at the low end. Loading may be achieved by a sandwich construction, in which one face of the dome is entirely coated, and the rubber layer further extends in a band around the edge of the diaphragm to suspend the diaphragm to its housing. A magnetic fluid is selectively placed in the gap to enhance heat transfer and coil centering. In addition to the aforementioned full range speaker, the speaker units assembled in the openings on the cylinder may be any other kinds of compact full-range speakers known in the art.

Therefore, the single column surround-sound speaker of the present invention utilizes the 3D sound field reconstruction technique to simulate real surround sound and produce treated sound signals from sound sources for the full-range speaker units in multiple arrangements to output toward different directions, so as to achieve surround sound effects with only one surround-sound speaker. Furthermore, the single column surround-sound speaker of the present invention can be placed anywhere in a room with the surround sound effects remained at the same level, and the size of the single column surround-sound speaker can be greatly decreased because of the compact full-range speaker units. Accordingly, the single column surround-sound speaker of the present invention can be convenient to use and position changeable and space-saving for the user.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the invention. It is intended that all such modifications and alterations are included insofar as they come within the scope of the invention as claimed or the equivalents thereof.

What is claimed is:

1. A three-dimension array structure of a surround-sound speaker, comprising:
a hollow pillar with at least three openings formed thereon spirally;
at least three full range speakers attached in said openings;
a base supporting said hollow pillar; and
a sound field reconstructing unit formed within said hollow pillar or said base or outside of said hollow pillar and said base, wherein said sound field reconstructing unit is coupled to said at least three full range speakers.

2. The structure of claim 1, wherein said at least three full range speakers are coupled with each other serially or parallelly.

3. The structure of claim 1, wherein said hollow pillar is made of metal, alloy, plastics, wood, or stainless steel.

4. The structure of claim 1, wherein said base is made of wooden boards.

5. The structure of claim 1, wherein the diameters of said openings are about 45 mm to 55 mm.

6. The structure of claim 1, wherein said sound field reconstructing unit comprises a digital signal processor.

7. The structure of claim 1, wherein said sound field reconstructing unit further comprises a digital delay circuit.

8. A three-dimension array structure of a surround-sound speaker, comprising:
a hollow pillar with at least three openings formed thereon asymmetrically or symmetrically;
at least three full range speakers attached in said openings;
a base supporting said hollow pillar; and
a sound field reconstructing unit formed within said hollow pillar or said base or outside of said hollow pillar and said base, wherein said sound field reconstructing unit is coupled to said at least three full range speakers.

9. The structure of claim 8, wherein said at least three full range speakers are coupled with each other serially or parallelly.

10. The structure of claim 8, wherein said hollow pillar is made of metal, alloy, plastics, wood, or stainless steel.

11. The structure of claim 8, wherein said base is made of wooden boards.

12. The structure of claim 8, wherein the diameters of said openings are about 45 mm to 55 mm.

13. The structure of claim 8, wherein said sound field reconstructing unit comprises a digital signal processor.

14. The structure of claim 8, wherein said sound field reconstructing unit further comprises a digital delay circuit.

15. A three-dimension array structure of a surround-sound speaker, comprising:
a hollow pillar with at least three openings formed thereon asymmetrically or symmetrically;
at least three full range speakers attached in said openings; and
a base supporting said hollow pillar.

16. The structure of claim 15, further comprising a sound field reconstructing unit formed within said hollow pillar or said base or outside of said hollow pillar and said base, wherein said sound field reconstructing unit is coupled to said at least three full range speakers.

17. The structure of claim 16, wherein said sound field reconstructing unit comprises a digital signal processor.

18. The structure of claim 16, wherein said sound field reconstructing unit further comprises a digital delay circuit.

19. The structure of claim 15, wherein said at least three full range speakers are coupled with each other serially or parallelly.

20. The structure of claim 15, wherein said hollow pillar is made of metal, alloy, plastics, wood, or stainless steel.

21. The structure of claim 15, wherein said base is made of wooden boards.

22. The structure of claim 15, wherein the diameters of said openings are about 45 mm to 55 mm.
